(19) United States
(12) Patent Application Publication
(10) Pub. No.: US 2023/0410686 A1
(43) Pub. Date: Dec. 21, 2023

(54) CHEMISTRY TEACHING AID FOR VISUALLY IMPAIRED STUDENTS

(71) Applicants: Roger P. Wolf, Butler, PA (US); Paula J. Wolf, Butler, PA (US)

(72) Inventors: Roger P. Wolf, Butler, PA (US); Paula J. Wolf, Butler, PA (US)

(21) Appl. No.: 18/333,144

(22) Filed: Jun. 12, 2023

Related U.S. Application Data
(60) Provisional application No. 63/352,448, filed on Jun. 15, 2022.

(51) Int. Cl. G09B 23/24; G09B 21/00

(52) U.S. Cl. CPC G09B 23/24; G09B 21/003

(57) ABSTRACT

A system for instructing chemistry includes a device including a work surface, a frame, and movable tiles. Each movable tile includes at least a portion of a visible chemistry symbol thereon readable via eyesight and Braille indicia corresponding to the visible chemistry symbol. Each of the movable tiles further includes an attachment member on a rearward surface to movably attach the moveable tile to the work surface. A storage device for of the system includes a plurality of separate compartments for the at least a portion of the moveable tiles arranged in space in the format of a periodic table. Each of the plurality of separate compartments includes a visible chemistry symbol and a Braille indicia for one of the plurality of chemical elements thereon.

### CROSS-REFERENCE TO RELATED APPLICATIONS

This application claims benefit of U.S. Provisional Patent Application Ser. No. 63/352,448, filed Jun. 15, 2022, the disclosure of which is incorporated herein by reference.

### BACKGROUND

The following information is provided to assist the reader in understanding technologies disclosed below and the environment in which such technologies may typically be used. The terms used herein are not intended to be limited to any particular narrow interpretation unless clearly stated otherwise in this document. References set forth herein may facilitate understanding of the technologies or the background thereof. The disclosure of all references cited herein are incorporated by reference.

Teaching devices and methodologies for use by visually impaired individuals/students in learning mathematics are described in U.S. Pat. Nos. 7,273,375; 7,500,852; and 8,287,280. In those devices, movable tiles, members or elements which include a visible mathematical symbol and braille indicia are movable around a work surface to create standard mathematical formulae. Although, such devices and methodologies have met with significant success in enabling visually impaired students to learn mathematics, adaptation to other topics, particularly chemistry, has yet to be realized.

### SUMMARY

In one aspect, a system for instructing chemistry includes a device including a work surface, a frame around the work surface, and movable tiles. Each of the movable tiles includes, on a front surface thereof, at least a portion of a visible chemistry symbol thereon readable via eyesight. Each of the movable tiles further includes Braille indicia on the front surface thereof corresponding to the at least a portion of the visible chemistry symbol. Each of the movable tiles further includes an attachment member on a rearward surface to attach the moveable tile to the work surface. The attachment member is adapted to allow the moveable tile to be removed from the work surface and to be slidably positionable to generally any position on the work surface once attached thereto. The frame defines an abutment boundary for positioning of the movable tiles. The system further includes a storage device for at least a portion of the movable tiles which includes a symbol of one of a plurality of chemical elements thereof. The storage device includes a plurality of separate compartments for the at least a portion of the moveable tiles. Each of the plurality of separate compartments includes a visible chemistry symbol of one of the plurality of chemical elements thereon readable via eyesight and a Braille indicia of the one of the plurality of chemical elements thereon. The plurality of separate compartments are arranged in space in the format/manner of a periodic table of elements. Moveable elements including indicia of a chemical element thereon may be stored in a compartment including corresponding indicia. Further compartments may be provided for moveable elements including indicia other than for chemical elements while maintaining the arrangement of the periodic table for the movable element including indicial of a chemical element.

In a number of embodiments, the work surface has sufficient surface area to provide for positioning a plurality of the moveable tiles around at least a portion of a perimeter of the work surface bounded by the frame from which the moveable tile can be slid to form a standard chemistry expression. Magnetic attraction may, for example, be used to maintain the attachment member in movable connection with the work surface.

In a number of embodiments, the system further includes one or more reference documents including information in the form of Braille indicia. The one or more reference documents may, for example, provide information in the form of Braille indicia on the plurality of chemical elements to supplement information provided on each of the plurality of separate compartments.

In a number of embodiments, the upper surface of the movable cover of each of the plurality of separate compartments further includes a visible indicia of an atomic number of the one of the plurality of chemical elements and the Braille indicia of the atomic number of the one of the plurality of chemical elements.

The system may, for example, further include a plurality of support components, wherein each of the plurality of support components includes a first seating via which one of the moveable tiles is positionable to be in operative connection with the support component. Each of the plurality of support components further includes an attachment member on a rearward surface to attach the support component to the work surface. The attachment member is adapted to allow the support component to be removed from the work surface and to be slidably positionable to generally any position on the work surface once attached thereto. The system may further include a plurality of extending bond line components. A user can, for example, form a structure on the work surface representing a molecule by arranging two or more of the plurality of support components (and associated movable tile(s) and/or other associated components) in spaced relation with one or more of the plurality of extending bond line components extending between the two or more of the plurality of support components. Magnetic attraction may, for example, be used to maintain the attachment member of each of the plurality of support components in movable connection with the work surface.

In a number of embodiments, each of the plurality of support components further includes a second seating via which one of the moveable tiles is positionable to be in operative connection with the support component. The first seating is dimensioned to seat one of the plurality of movable tiles having a first size, and the second seating being dimensioned to seat one of the plurality of movable tiles having a second size, different from the first size.

One or more of the plurality of extending bond line components may, for example, include an attachment member on a rearward surface to attach the extending bond line component to the work surface, the attachment member being adapted to allow the extending bond line component to be removed from the work surface and to be slidably positionable to generally any position on the work surface once attached thereto.

Each of the one or more of the plurality of extending bond line components may, for example, include, on a front surface thereof, a visible representation thereon, readable via eyesight, of one of a single bond, a double bond, a triple bond or a quadruple bond. Each of the extending bond line components further includes Braille or other tactile indicia on the front surface thereof corresponding to the one of the single bond, the double bond, the triple bond or the quadruple bond.

In a number of embodiments, one or more of the of the plurality of extending bond line components includes an adhesive surface to removably attach the extending bond line component to the work surface. A single bond line may be represented by one of one or more extending bond line components, a double bond line may be represented by two of one or more extending bond line components, a triple bond line may be represented by three of one or more extending bond line components, and a quadruple bond line may be represented by four of one or more extending bond line components.

In a number of embodiments, each of the plurality of separate compartments independently includes a movable cover comprising the visible chemistry symbol of one of the plurality of chemical elements and the Braille indicia of the one of the plurality of chemical elements on an upper surface thereof. In a number of embodiments, the movable cover of each of the plurality of separate compartments is connected to a body of each of the plurality of separate compartments via a hinge mechanism.

In another aspect, a device for instructing chemistry includes a work surface, a frame around the work surface, and movable tiles. Each of the movable tiles includes, on a front surface thereof, at least a portion of a visible chemistry symbol thereon readable via eyesight, Each of the movable tiles further includes Braille indicia on the front surface thereof corresponding to the at least a portion of the visible chemistry symbol. Each of the movable tiles further includes an attachment member on a rearward surface to attach the moveable tile to the work surface. The attachment member is adapted to allow the moveable tile to be removed from the work surface and to be slidably positionable to generally any position on the work surface once attached thereto. The frame defines an abutment boundary for positioning of the movable tiles. The movable tiles include a plurality of chemical element tiles and a plurality of moveable tiles including a visible chemistry symbol of one of the plurality of chemical elements thereon readable via eyesight and a Braille indicia of the one of the plurality of chemical elements thereon.

The device further includes a plurality of support components. Each of the plurality of support components includes a first seating via which one of the moveable tiles is positionable to be in operative connection with the support component. Each of plurality of support components further includes an attachment member on a rearward surface to attach the support component to the work surface. The attachment member is adapted to allow the support component to be removed from the work surface and to be slidably positionable to generally any position on the work surface once attached thereto. The device further includes a plurality of extending bond line components, wherein a user can form a structure on the work surface representing a molecule by arranging two or more of the plurality of support components (and associated moveable tile(s) and/or other associated components) in spaced relation with one or more of the plurality of extending bond line components extending between the two or more of the plurality of support components. As described above, magnetic attraction may, for example, be used to maintain the attachment member of each of the plurality of support components in movable connection with the work surface.

In a number of embodiments, each of the plurality of support components further includes a second seating via which one of the moveable tiles is positionable to be in operative connection with the support component. The first seating is dimensioned to seat one of the plurality of movable tiles having a first size, and the second seating being dimensioned to seat one of the plurality of movable tiles having a second size, different from the first size.

One or more of the plurality of extending bond line components may, for example, include an attachment member on a rearward surface to attach the extending bond line component to the work surface, the attachment member being adapted to allow the extending bond line component to be removed from the work surface and to be slidably positionable to generally any position on the work surface once attached thereto.

Each of the one or more of the plurality of extending bond line components may, for example, include, on a front surface thereof, a visible representation thereon, readable via eyesight, of one of a single bond, a double bond, a triple bond or a quadruple bond. Each of the extending bond line components further includes Braille or other tactile indicia on the front surface thereof corresponding to the one of the single bond, the double bond, the triple bond or the quadruple bond.

In a number of embodiments, one or more of the of the plurality of extending bond line components includes an adhesive surface to removably attach the extending bond line component to the work surface. A single bond line may be represented by one of one or more extending bond line components, a double bond line may be represented by two of one or more extending bond line components, a triple bond line may be represented by three of one or more extending bond line components, and a quadruple bond line may be represented by four of one or more extending bond line components.

In a number of embodiments, the work surface has sufficient surface area to provide for positioning of a plurality of the moveable tiles around at least a portion of a perimeter of the work surface bounded by the frame from which the moveable tile can be slid to form a standard chemistry expression. In a number of embodiments, magnetic attraction is used to maintain the attachment member in movable connection with the work surface.

In a further aspect, a device for instructing chemistry includes a work surface, a frame around the work surface, and movable tiles. Each of the movable tiles includes, on a front surface thereof, at least a portion of a visible chemistry symbol thereon readable via eyesight. Each of the movable tiles further includes Braille indicia on the front surface thereof corresponding to the at least a portion of the visible chemistry symbol. Each of the movable tiles further includes an attachment member on a rearward surface to attach the moveable tile to the work surface. The attachment member is adapted to allow the moveable tile to be removed from the work surface and to be slidably positionable to generally any position on the work surface once attached thereto. The frame defines an abutment boundary for positioning of the movable tiles.

In a number of embodiments, the work surface has sufficient surface area to provide for positioning a plurality of the moveable tiles around at least a portion of a perimeter of the work surface bounded by the frame from which the moveable tile can be slid to form a standard chemistry expression. In a number of embodiments, magnetic attraction is used to maintain the attachment member in movable connection with the work surface.

The present devices, systems, and methods, along with the attributes and attendant advantages thereof, will best be appreciated and understood in view of the following detailed description taken in conjunction with the accompanying drawings.

### BRIEF DESCRIPTION OF THE DRAWINGS

FIG. 1A illustrates a top plan view of the working space of an embodiment of a device hereof.

FIG. 1B illustrates a top plan view of the device hereof illustrating the frame surrounding the work space, wherein the tiles of the various formulas are significantly enlarged for increased clarity.

FIG. 1C illustrates representative examples of creating chemical formulas (for example, water and indigo die), creating formulas for calculations (for example, density), representing constants (for example, Avogadro's constant), and representing ions (for example, a carbonate ion and a lithium ion) using arrangements of single tiles in a device hereof.

FIG. 1D illustrates representative examples of creating balanced chemical equations (for example, for the reactions of sodium chloride and sulfuric acid as well as nitrogen and hydrogen) using arrangements of single tiles in a device hereof.

FIG. 1E illustrates representative examples of creating balanced chemical equations for nuclear reactions (for example, alpha decay, beta decay, fission reactions, and fusion reactions) using arrangements of single tiles in a device hereof.

FIG. 1F illustrates embodiments of three manners of representing the molecule ethane using components of a device hereof.

FIG. 1G illustrates embodiments of three manners of representing the molecule ethene using components of a device hereof.

FIG. 2A illustrates an enlarged isometric view of a smaller-sized or dimensioned tile for the element carbon (C).

FIG. 2B illustrates an enlarged isometric view of a larger-sized or dimensioned tile for the element iron (Fe).

FIG. 3A illustrates an enlarged top plan view of an embodiment of a support tile or component without an element or other movable tile in a first seating thereof.

FIG. 3B illustrates an enlarged top plan view of an embodiment of the support tile or component of FIG. 3A with a movable tile hereof positioned in connection with a first seating thereof, which is formed as a passage or depression therein.

FIG. 3C illustrates an enlarged top plan view of an embodiment of the support tile of FIG. 3A with a larger-sized movable tile hereof positioned in connection with a second seating formed thereof, which is formed or defined via raised sections formed thereon.

FIG. 3D illustrates an enlarged top plan view the use of element tiles, support tiles or components, and extending bond line components in forming a bond diagram of a water molecule (H₂O).

FIG. 3E illustrates an enlarged top plan view of the use of element tiles, support tiles or components, and extending, individual bond line members or components in forming a bond diagram of a water molecule.

FIG. 4A illustrates an enlarged top plan view of extending bond line components or tiles hereof representing single bonds, double bonds, triple bonds, and quadruple bonds.

FIG. 4B illustrates an enlarged top plan view of the use of extending bond line components hereof, in the form of individual bond line members/components, in representing single bonds, double bonds, triple bonds, and quadruple bonds.

FIG. 5A illustrates a top plan view of two sections that are attachable to form a periodic table which also operates as a tile storage device.

FIG. 5B illustrates an enlarged top plan view of the first or left-side section of the two sections which are attachable to form the periodic table/storage device of FIG. 5A.

FIG. 5C illustrates an enlarged top plan view of the second or right-side section of the two sections which are attachable to form a periodic table/storage device of FIG. 5A.

FIG. 5D illustrates a top plan the two sections of FIGS. 5A through 5C in an attached state.

FIG. 5E illustrates an enlarged cross-sectional view of a portion of each of the two sections in a detached state and an attached state showing the cooperation or interconnection of the cooperating attachment elements thereof in the attached state.

FIG. 5F illustrates an enlarged top plan view of a portion of the periodic table/storage device of FIGS. 5A and 5B in which a movable cover or lid of one of the compartments (that is, the compartment for radium or Ra) is opened, showing movable tiles for the element Ra therein.

FIG. 6A illustrates representative examples of chemistry indicia or symbols that may be included on movable tiles hereof.

FIG. 6B illustrates additional representative examples of chemistry indicia or symbols that may be included on movable tiles hereof.

FIG. 6C illustrates additional representative examples of chemistry indicia or symbols that may be included on movable tiles hereof.

FIG. 7A illustrates an embodiment of a reference sheet including further information on chemical elements in characters and Braille.

FIG. 7B illustrates a reference sheet including the periodic table of elements.

### DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As used herein and in the appended claims, the singular forms “a,” “an”, and “the” include plural references unless the context clearly dictates otherwise. Thus, for example, reference to “a moveable tile” includes a plurality of such moveable tiles and equivalents thereof known to those skilled in the art, and so forth, and reference to “the moveable tile” is a reference to one or more such moveable tiles and equivalents thereof known to those skilled in the art, and so forth. Recitation of ranges of values herein are merely intended to serve as a shorthand method of referring individually to each separate value falling within the range. Unless otherwise indicated herein, and each separate value as well as intermediate ranges are incorporated into the specification as if it were individually recited herein. All methods described herein can be performed in any suitable order unless otherwise indicated herein or otherwise clearly contraindicated by the text.

As described above, teaching devices; systems, and methodologies for instructing visually impaired students in mathematics are described in U.S. Pat. Nos. 7,273,375, 7,500,852, and 8,287,280, the disclosures of which are incorporated herein by reference. Providing instructions in chemistry to the visually impaired remains a difficult task. It can be quite difficult, for example, for an instructor and a student to organize the large number of movable elements and have them readily accessible for problem solving. This issue presents particular difficulties in chemistry wherein there are many diverse symbols and arrangements thereof.

Devices, systems, and methods hereof include a work surface and a frame around the work surface. A plurality of movable tiles (which are movable to different positions on the work surface) and/or other components hereof may include, on a top, upper or front surface thereof, at least a portion of a visible chemistry symbol thereon which is readable via eyesight. Each of the movable tiles and/or other components may further includes Braille and/or other tactile indicia on the front surface thereof corresponding to the at least a portion of or representing the visible chemistry symbol. Each of the movable tiles and/or other components further includes an attachment member on a rearward or bottom surface to attach the moveable element and/or other component to the work surface. The attachment member may, for example, be adapted to allow the moveable tile and/or other component to be removed from the work surface and/or to be slidably positionable to generally any position on the work surface once attached thereto. The frame defines an abutment boundary for positioning of the movable tiles and/or other components.

In a number of embodiments, an organized, multi-compartment storing device for moveable tiles hereof representing the known elements is provided in the manner, form or format of the periodic table of the elements. Such a storage device allows an instructor and a student to readily find the needed element movable tiles and, at the same time, enhances their familiarity with the periodic table of elements. Furthermore, in a number of embodiments hereof creating or building bonded structures in the devices, systems, and methods hereof is facilitated by using a combination of tiles hereof in which moveable tiles including element indicia or symbols are placed within another movable tile in the form of a support element/component which facilitates the positioning of various bond types therearound.

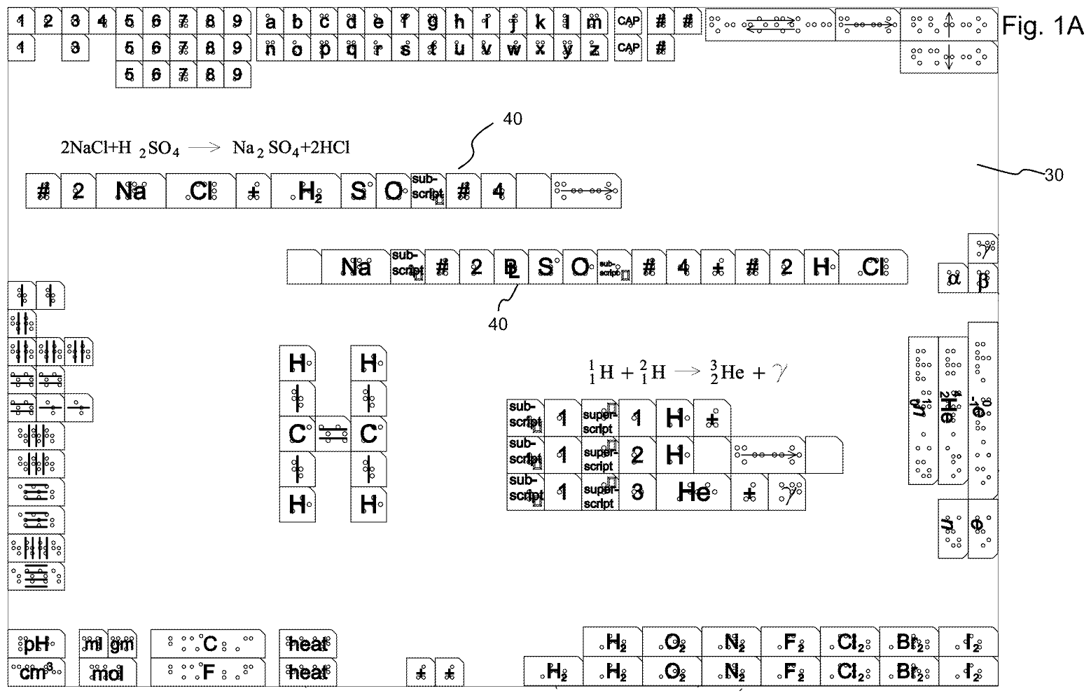

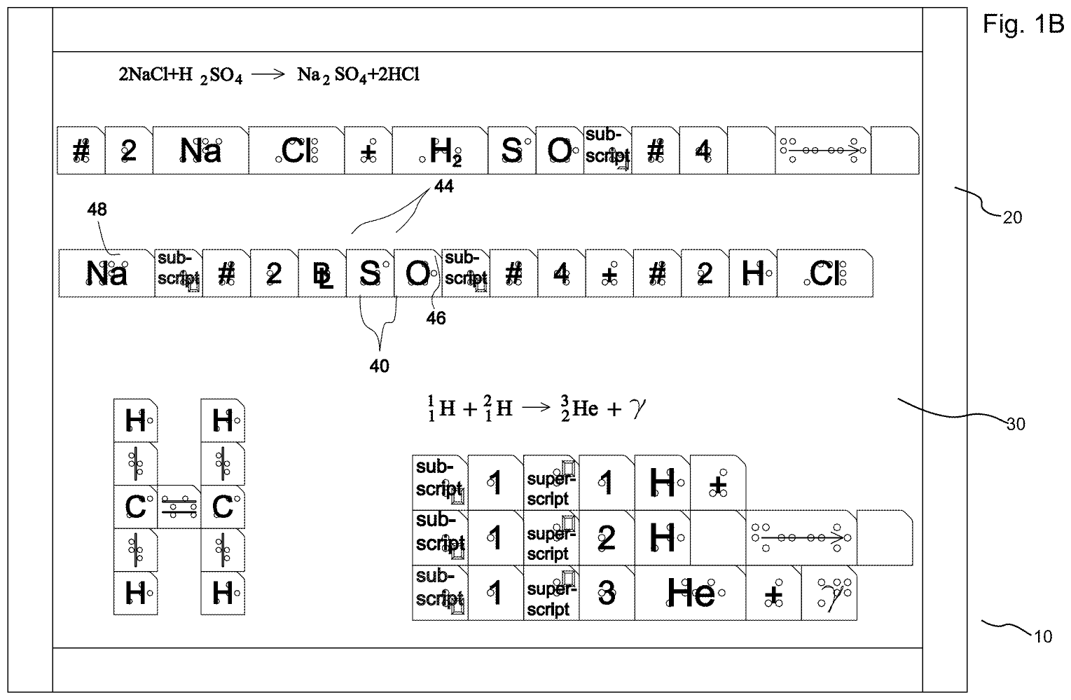

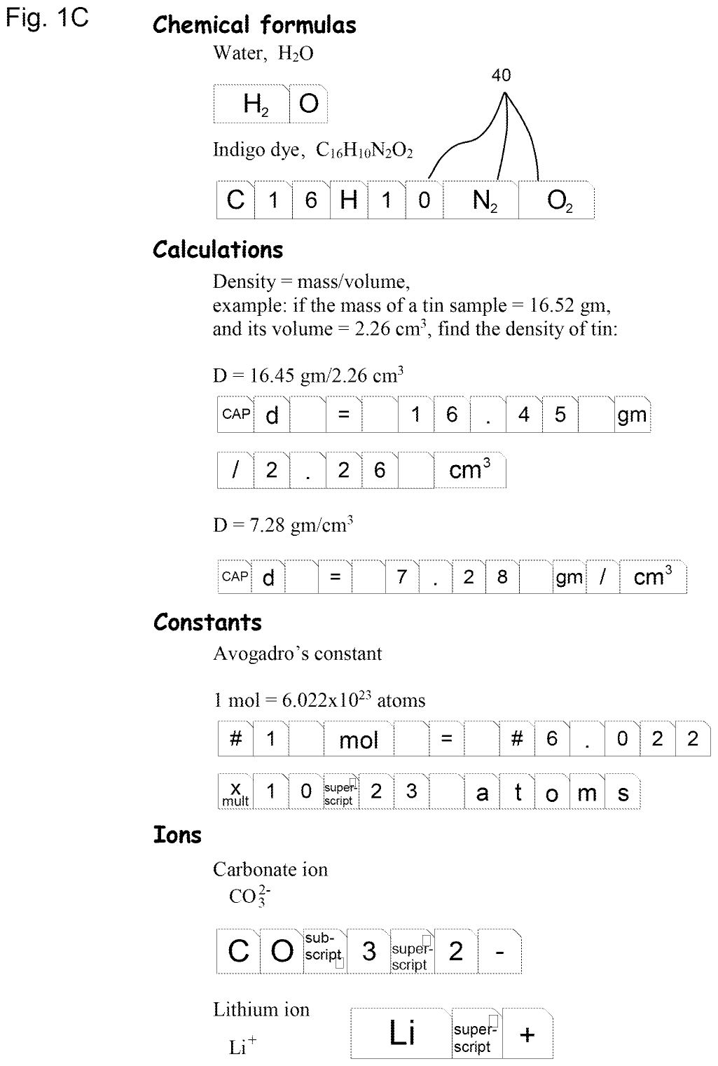

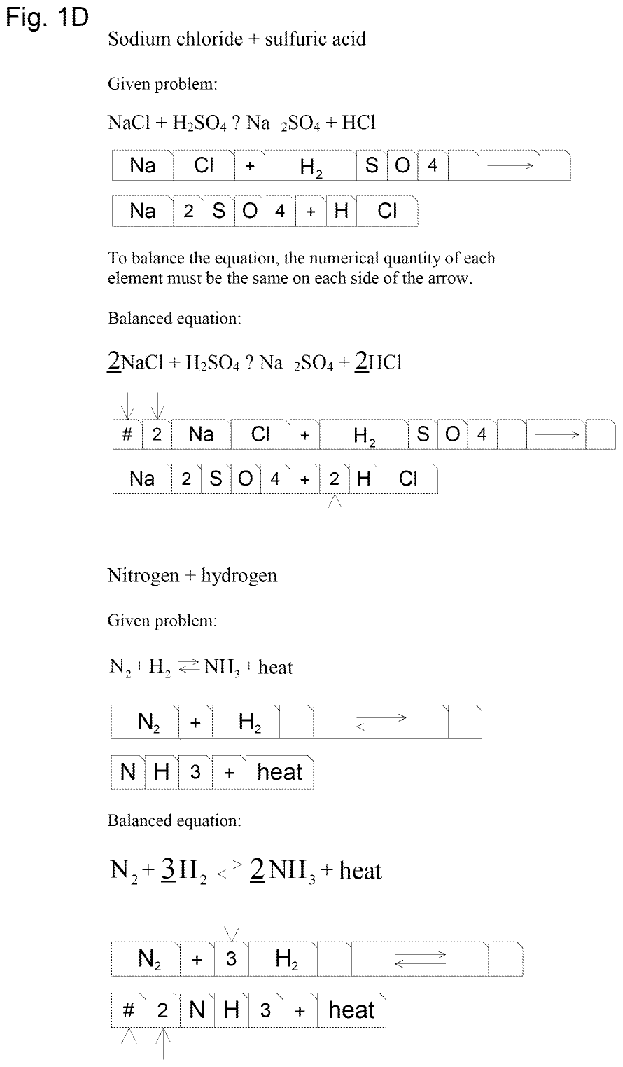

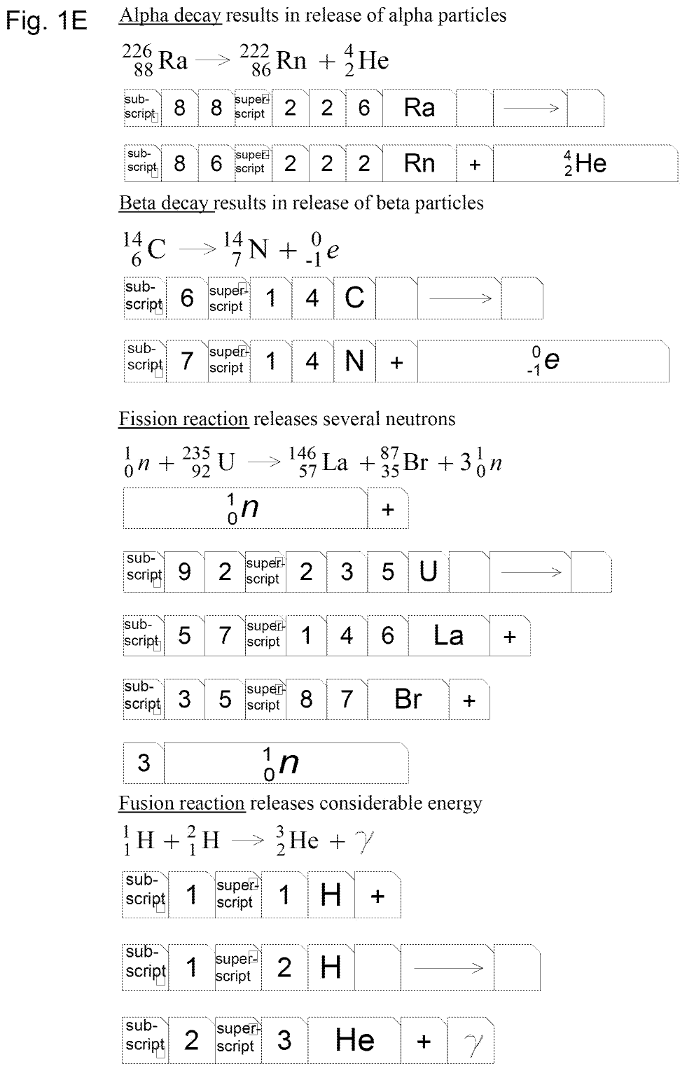

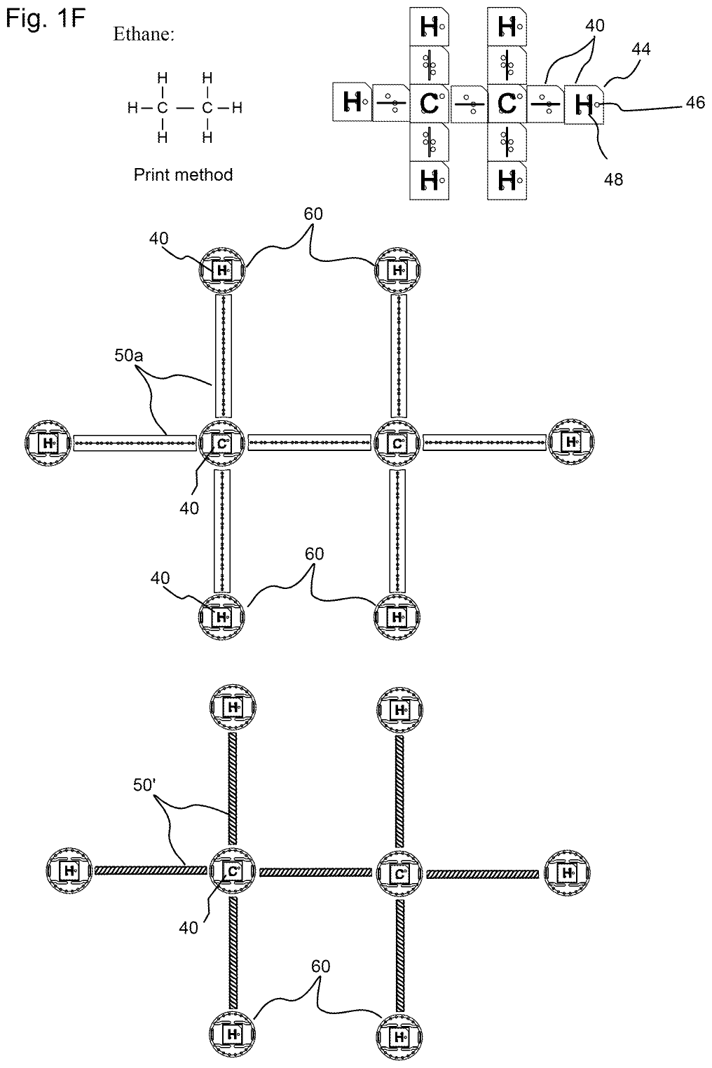

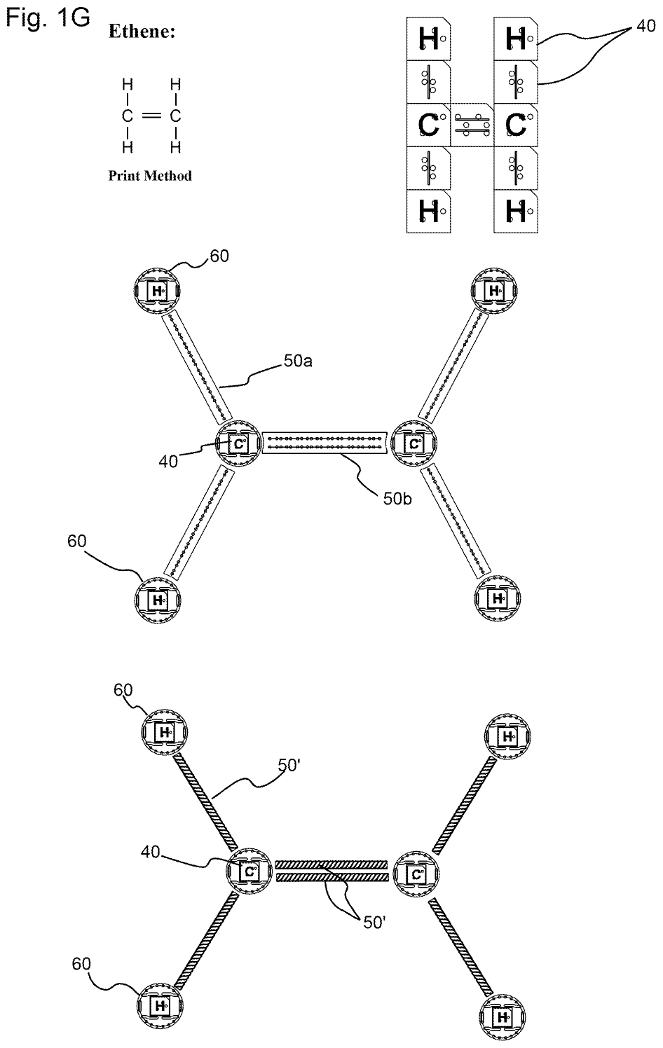

FIGS. 1A through 7B illustrate embodiments of a teaching aid, system and/or method hereof (and/or components thereof) for use in instructing blind or otherwise visually impaired students in chemistry. As used herein, the term “visually impaired” refers generally to a person having eyesight substantially below average (including the blind), which impairs their ability to, for example, follow instructions or lessons displayed in a classroom (for example, on a blackboard). In the case of visual impairment, a person's eyesight typically cannot be corrected to a “normal” level. The World Health Organization defines “low vision” as visual acuity between 20/70 and 20/400, with the best possible correction, or a visual field of 20 degrees or less. “Blindness” is defined as a visual acuity worse than 20/400, with the best possible correction, or a visual field of 10 degrees or less. In the United States, legal blindness is defined as a visual acuity of 20/200 or worse, with the best possible correction, or a visual field of 20 degrees or less.

As illustrated in FIGS. 1A and 1B, and particularly FIG. 1B, an embodiment of a teaching aid system/device 10 hereof includes a frame 20 surrounding a work surface or work board 30 on which a visually impaired student can assemble movable character/symbol elements or tiles 40 into chemical reactions, molecules, processes etc. much as a sighted student would use a blackboard, a piece of paper or a marker board. Moveable tiles 40 (either alone or in connection with other components of device 10) may, for example, include indicia of elements (for example, all currently known elements), compounds, equations, bond lines, arrows, numbering, fraction indicators, superscripting, subscripting, etc. as, for example, further described below.

FIG. 1A, for example, illustrates movable tiles 40 positioned around a perimeter of board 30, and replicates the balanced chemical equation for the reaction of sodium chloride (NaCl) and sulfuric acid (H₂SO₄), a representative of the molecule ethane and a representation of a fusion reaction in which helium (He) is formed from two atoms of hydrogen (H). Board 30 and movable tiles 40 are drawn approximately to scale from one embodiment of device 10 in FIG. 1A. In FIG. 1B, the representation of the reaction of sodium NaCl and sulfuric acid H₂SO₄, the representative of the molecule ethane, and the representation of the fusion reaction in which He is formed from two atoms of H are enlarged relative to board 30 and the remainder of device 10 for clarity. Movable tiles 40 on the perimeter of board 30 are also excluded from FIG. 1B.

FIG. 1C illustrates representative examples of creating chemical formulas (for example, water and indigo die), creating formulas for calculations (for example, density), representing constants (for example, Avogadro's constant), and representing ions (for example, a carbonate ion and a lithium ion) using arrangements of single movable tiles 40 in a device hereof. In the chemical formula for water, movable tile 40 for diatomic oxygen is used. As illustrated in the formula for indigo dye, movable tiles 40 including numeric indicia are used for indicating the number of atoms of the elements carbon (C16) and hydrogen (H10) in the formula, after the movable tile for the corresponding element. In the illustrated representation, the subscription of such numbers (as noted in the printed version of the formula typically used for sighted individuals) is understood. Movable tiles for diatomic nitrogen (N₂), and diatomic oxygen (O₂) are used in the formula.

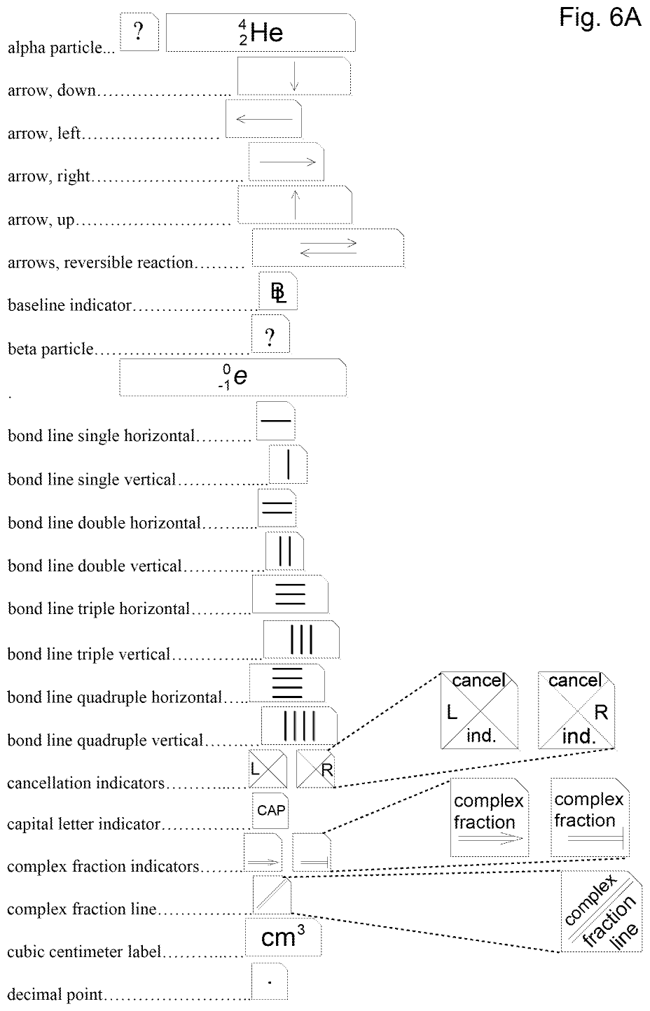

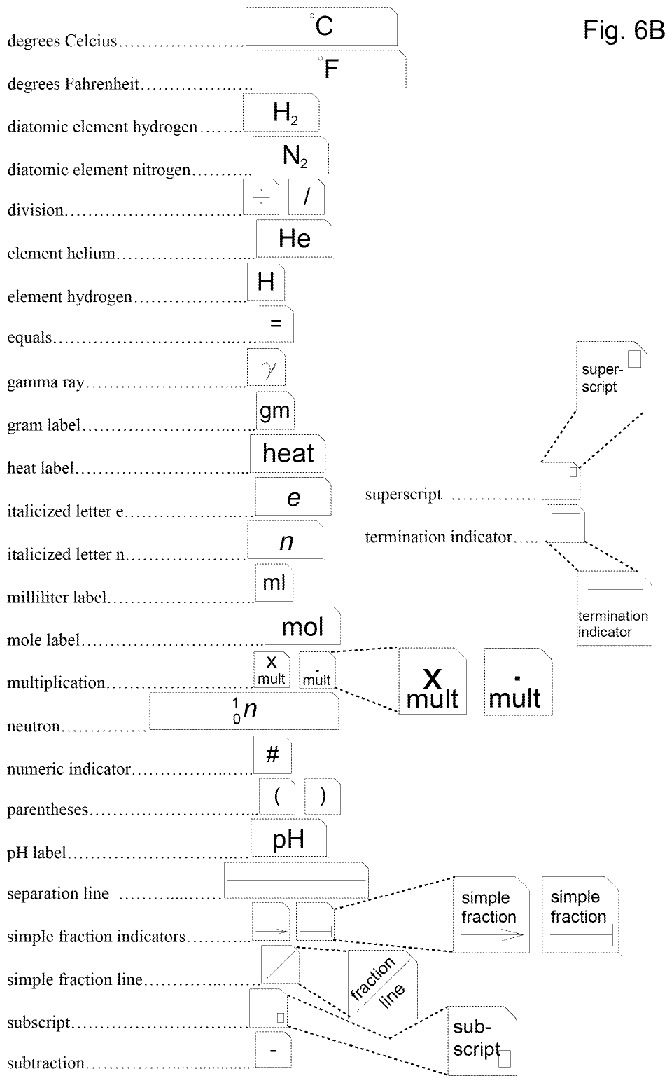

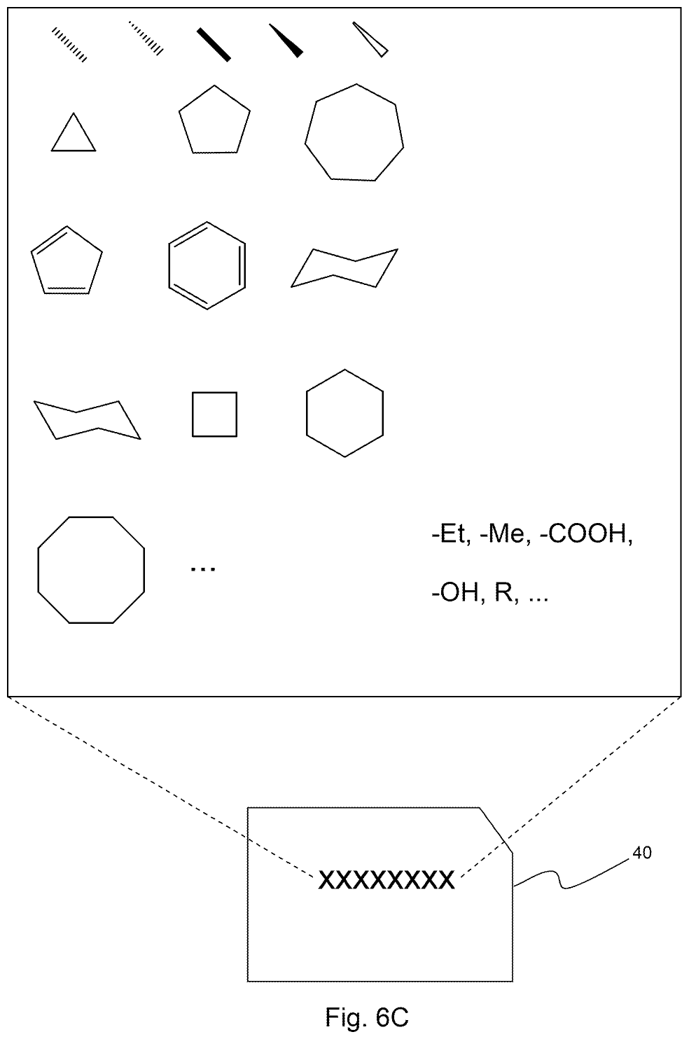

An illustration of a number of representative movable tiles 40 available in a number of embodiments of device or system 10 hereof is provided FIGS. 6A and 6B. FIG. 6C illustrates representative examples of further chemical indicia or symbols (for example, bonds representations, cyclic chemical group representations, common chemical groups (such as, ethyl (Et), methyl (Me), carboxyl (COOH), hydroxyl (OH), variable substituent group (R), etc.)). Those skilled in the art appreciate that many additional chemistry indicia or symbols may be provided that may be context or subject-matter specific (for example, in extended tile sets for advanced users). Users may also be provided the opportunity to form custom tiles 40 by the provision of “blank” tiles upon which the user may include chemical indicia or symbols as well as Braille indicia.

The representation of the calculation of density in FIG. 1C illustrates the use of a preceding movable element to indicate capitalization (CAP) of the following alphanumeric movable tile, a blank or space movable tile, and equal sign movable tile, a division movable tile, a decimal place movable tile, and two movable tiles representing units (gm, and cm³). The representation of Avogadro's constant in FIG. 1C illustrates the use of the preceding movable element including a number symbol (#) to indicate that the following movable tile is a number. The number symbol may, for example, be used in cases in which there may be a possibility of confusion that the adjacent/following tile is a numeral in the context of use. For example, in Nemeth Braille Code and Unified English Braille (UEB), the designation for numerals are similar or the same as the first ten letters. In Nemeth Braille Code, the designations are the same but moved downward one dot in spacing. In UEB, the designation for the first ten numerals are the same as the first ten letter. In use instances where there is room for interpretation or doubt, the number symbol may be used to provide an unequivocal designation.

The representation of Avogadro's constant also illustrates the use of a movable element for moles (mol), a multiplication symbol (x), a preceding superscript movable element including the symbol and a tactile indicator (°) to indicated that the following movable tiles are superscripted, and the use of alphanumeric movable tiles to spell the word “atoms”. The representation of the carbonate ion in FIG. 1C illustrates the use of a preceding superscript movable tile and a preceding subscript moveable tile (including a tactile indicator (□)) in connection with (i) the numeric movable tile 3 and (ii) the numeric movable tile 2 and the movable tile setting forth a negative sign (−), respectively, following the numeric tile for oxygen to indicate that 3 oxygen atoms are attached to the carbon atom and the charge of the ion is negative 2.

FIG. 1D illustrates representative examples of creating balanced chemical equations (for example, for the reactions of sodium chloride and sulfuric acid, as also represented in FIGS. 1A and 1B, as well as nitrogen and hydrogen) using arrangements of single tiles in a device hereof. The representative examples illustrate, for example, the use of a movable tile including an arrow (→) to indicate the direction of reaction, a movable element including stacked, oppositely oriented arrows (⇄) to indicate a reversible reaction, and a movable tile including the word “heat” to indicate the production of heat in the reaction.

FIG. 1E illustrates representative examples of creating balanced chemical equations for nuclear reactions (for example, alpha decay, beta decay, fission reactions, and fusion reactions) using arrangements of single tiles in a device hereof. The equation for the alpha decay of radium-226 illustrates the use of a moveable tile representing an alpha particle (₂⁴He) as known in the chemical arts. In the equation for the beta decay of carbon-14, a movable tile representing an electron (₋₁⁰e) as known in the chemical arts is illustrated. In the equation for a fission reaction, a movable tile representing a neutron (₀¹n) as known in the chemical arts is illustrated. The equation for a fusion reaction illustrates the use of a movable tile representing the Greek letter gamma/energy (γ) as known in the chemical arts.

FIG. 1F and FIG. 1G illustrate embodiments of three different manners of representing the molecules ethane and ethene, respectively, via bond diagrams using tiles/components of a device 10 hereof FIG. 1F illustrates the print method of representing the molecule ethane often used for sighted individuals. Adjacent to the print method representation, FIG. 1F also illustrates use of the use of a croup of individual movable tiles 40 hereof in forming a bond diagram including movable tiles 40 including bond lines. That representation is quite similar in visual appearance to the print method of representing the molecule of ethane.

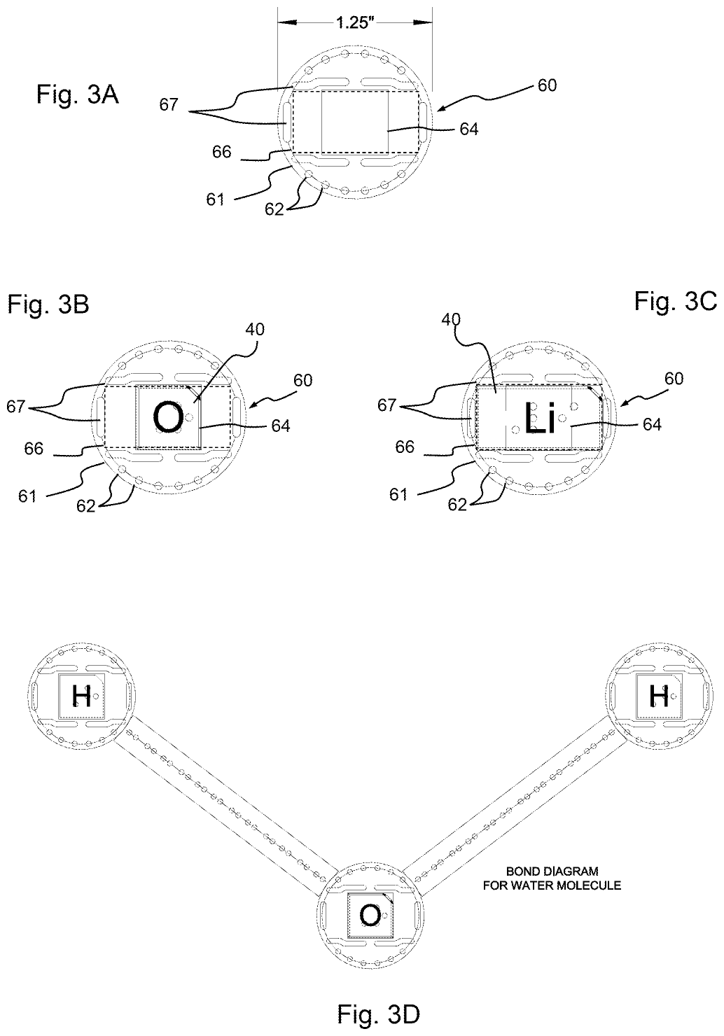

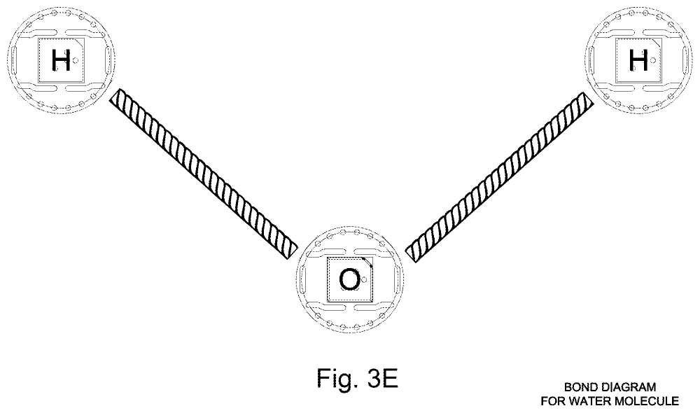

Immediately below the print method representation, FIG. 1F further illustrates an alternative manner of making or forming bond diagrams using extending bond line tiles or components 50a (representing a single bond line) in connection with frame/support tiles or components 60. Support components 60, which may be considered a type of movable tile hereof, do not include indicia of specific elements or other substituent group of a molecule, but are for use in connection with moveable tiles 40 including indicia of elements or other substituent groups of molecules. Referring, for example, to FIGS. 3A and 3B, support components 60 may be shaped (for example, polygonal or circular) to, for example, facilitate positioning chemical bond representations such as extending bond line components 50a therearound at any angle. Support components 60 may potentially provide a better correspondence to the manner in which chemical bonds are presented to sighted individuals. Support components 60 may, for example, be used to better represent bond angles and/or bond lengths as described below.

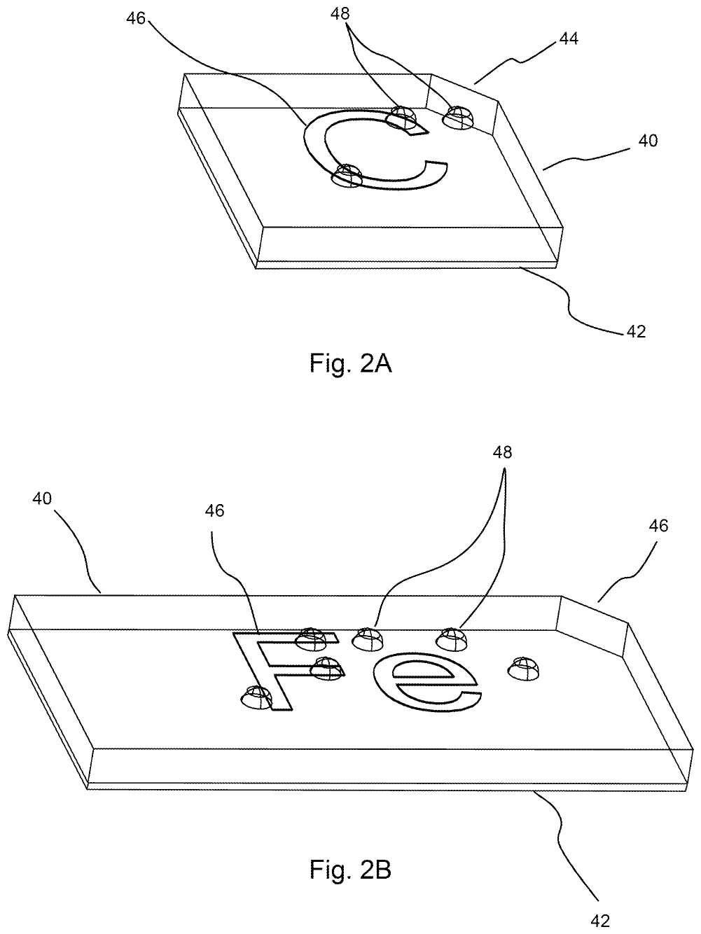

In the illustrated embodiment, a support component 60 includes a raised perimeter 61 and optional raised circular element 62 to assist in defining the perimeter and/or orientation thereof. Support components 60 include a first seating or retaining section such as a depression, hole or passage 64 in which one of moveable tiles 40 having a first size or dimension (for example, smaller-sized/moveable tiles 40, including, for example, indicia for a single-letter element such as oxygen (O), carbon (C) or hydrogen (H)—see, for example, FIG. 2A) is positioned, seated or retained. In the illustrated embodiment, support component 60 further includes a second seating or retaining section 66 for seating or retaining, one of movable tiles 40 having a second size or dimension (for example, larger-sized movable tiles 40). Larger-sized movable tiles 40 may, for example, include indicia for multi-letter elements such as lithium (Li) (see, for example, FIG. 2B) or other multi-letter substituent groups, or symbols. Second seating 66 may also be used to seat groups of smaller-sized movable tiles 40 (which may be used collectively to represent information such as groups of elements or substituent groups as known in the chemical arts). Second seating 66 is defined by raised or upward-extending members 67 formed on an upper surface of support component. Seating 67 is used to place one or more tiles on top of or on the surface of support component 60. Depending upon whether tile backing 42 is magnetic or a ferromagnetic metal, seating 67 may include one or more sections of ferromagnetic metal or magnetic material to assist in forming a secure connection. Raised members, depressions, and/or other seating, retention or positioning mechanisms (for example, flanges etc.) may be used on the surface of support components 60 hereof to help position and maintain the position of one or more movable tiles 40 thereon. Similar to movable tiles 40, support components 60 may, for example, include a magnetic (or ferromagnetic metal) backing (not illustrated but essentially identical to magnetic backing 42) to place them in movable connection with board 30.

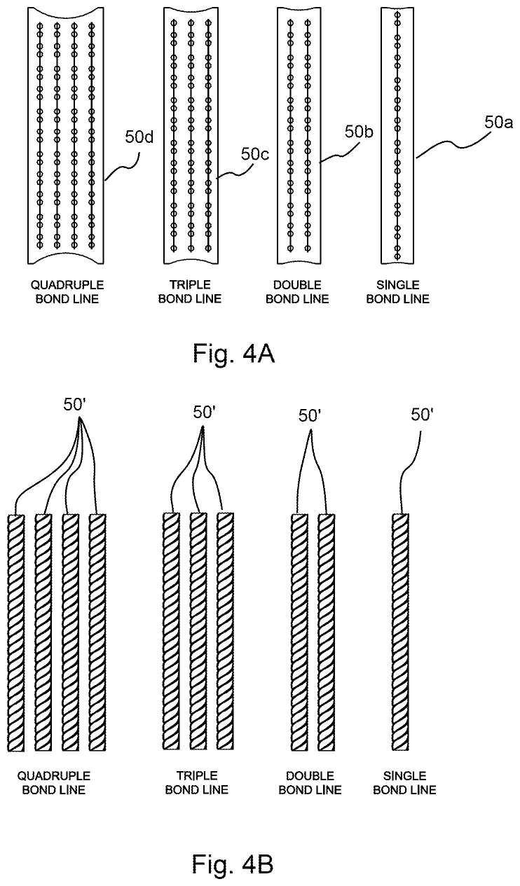

Once again referring to FIG. 1F, extending bond components 50a with single bond indicia are used to represent bond connections between the elements represented by element movable tiles 40 seated in/or support components 60. As, for example, illustrated in FIG. 4A, various extending bond components such as extending bond components 50a, 50b, 50c and 50d may be provided to provide indicia of a single bond, a double bond, a triple bond and a quadruple bond, respectively. The use of extending bond component 50b is, for example, used in connection with FIG. 1G to represent the double bond in the molecule ethene. As clear to one skilled in the art, extending bond component 50c may be used in representing the triple bond in the molecule ethyne (not illustrated). Similar to movable tiles 40, support extending bond components 50 may, for example, include a magnetic (or ferromagnetic metal) backing (not illustrated but essentially identical to magnetic backing 42) to place them in movable connection with board 30.

At the bottom thereof, FIG. 1G illustrates a third alternative to form a bond diagram of the molecule ethane using individual bond line components 50′. As illustrated in, for example, FIG. 4B, one, two, three, and four adjacent individual bond line components 50′ are used in representing a single bond, a double bond, a triple bond and a quadruple bond, respectively. The use of two individual bond line components 50′ is, for example, illustrated in FIG. 1G to represent the double bond in the molecule ethene. As clear to one skilled in the art, three individual bond line components 50′ may be used in representing the triple bond in the molecule ethyne (not illustrated). Individual bond line components 50′ may be flexible to enable angled, curved or curvilinear representations. In a number of embodiments, at least a portion of a surface of individual bond line components 50′ is adhesive to enable removable attachment to working surface 20.

In a number of embodiments, extending bond components 50a-d as well as individual bond line components 50′ may be adjusted in length (for example, using scissors) to control/represent bond length. In a number of embodiments, extending waxy element such as WIKKI STIR® (available from Omnicor, Inc. of Phoenix, AZ USA). Such waxy extending elements are self-sticking or adhesive and do not require an attachment mechanism such as a magnetic/ferromagnetic metal backing.

Support components 60 may thus be connected via extending bond (line) components 50a-d and/or individual, extending bond (line) components 50′ (representing, for example, single, double, triple bonds, or quadruple bonds) to represent bond connections between various atoms or substituent groups. Various sizes and shaped support components 60 and/or bond line components 50a-d, 50′ may be provided or used. A broad range of bond angles and lengths may be represented as for example, illustrated in FIGS. 1F, 1G, 3D and 3E.

As discussed above in connection with, for example, FIGS. 2A and 2B, magnetic attraction may be used to maintain movable tiles 40, extending bond components 50a-d, support components 60, and/or other components in movable connection with board 30. Board 30 may, for example, be magnetically receptive (for example, the board can include a magnetically receptive, ferrous or ferromagnetic metal) and each of movable tiles 40 for assembling the chemistry, molecules, processes etc. includes a magnetic backing 42 (see FIGS. 2A and 2B) so that moveable tiles 40 are easily moved around board 30 but remain in place when positioned in a desired area. Alternatively, board 30 can be magnetic and movable tiles 40 can include a magnetically receptive material as a backing. In a number of embodiments, moveable tiles 40 and board 30 are formed so that moveable tiles 40 are readily and quickly slidable on the work surface of board 30 to form chemistry representations (for example, chemical molecules, equations, processes etc.) at generally any position on board 30. Moreover, the symbols of moveable tiles 40 and other components hereof are such that the chemistry representations on board 30 substantially or closely resemble or match the form and appearance of chemistry representations used to explain chemistry to sighted students. For components in which orientation is not otherwise obvious, one or more location or orientation guides such as an angled or notched upper right corner 44 on movable tiles 40, as illustrated, for example, in FIGS. 2A and 2B, can be provided to help a visually impaired or blind student properly orient movable tiles 40.

Frame 20 may, for example, be formed from wood or plastic and work surface or board 30 may be formed from painted steel. Other magnetically receptive materials such as a plastic sheet with ferrous particles therein could be used for board 30. Preferably, the surface of board 30 is generally smooth to facilitate sliding of movable tiles 40 thereon. In a representative embodiment, movable tiles 40, extending bond line components 50a-d, and support components 60 were fabricated with a polymeric (for example, vinyl) material. In a number of embodiments, a clear polycarbonate sheet is printed backwards (for example, in black) with letters, symbols, etc. in the case of movable tiles 40. Subsequently, a background (for example, a white background) may be screen printed over the black letters. The sheet is then embossed with Braille indicia/dots, protruding outward on the non-printed side. The sheet is then laminated to a magnetic sheet and cut into tiles. Magnetic backing 42 is preferably sufficiently strongly magnetic to hold movable tiles 40 in place, for example, when board 30 is in a vertical or other orientation and when lightly touched for reading by a visually impaired student, while allowing movable tiles 40 to be slid around the surface of board 30 without use of excessive force.

As illustrated, for example, in FIGS. 2A and 2B, in addition to a visible chemistry symbol or a portion of a chemical symbol 46 as described above (which is readable by a sighted person), the front surface of each movable tiles 40 also includes indicia of the visible symbol that is “readable” or understandable by a visually impaired person using the sense of touch. For example, the front of each of movable tiles 40 can include raised indicia 46 (see FIGS. 2A and 2B) as commonly used in, for example, the Nemeth Braille Code system or the Unified English Braille (UEB).

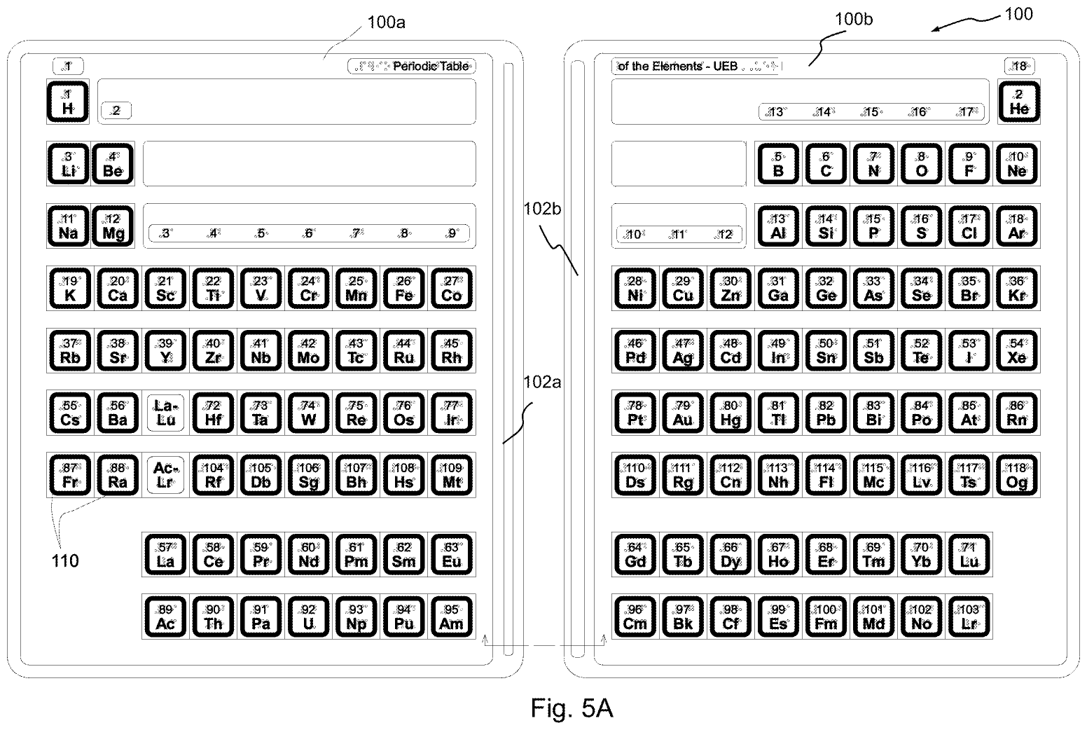

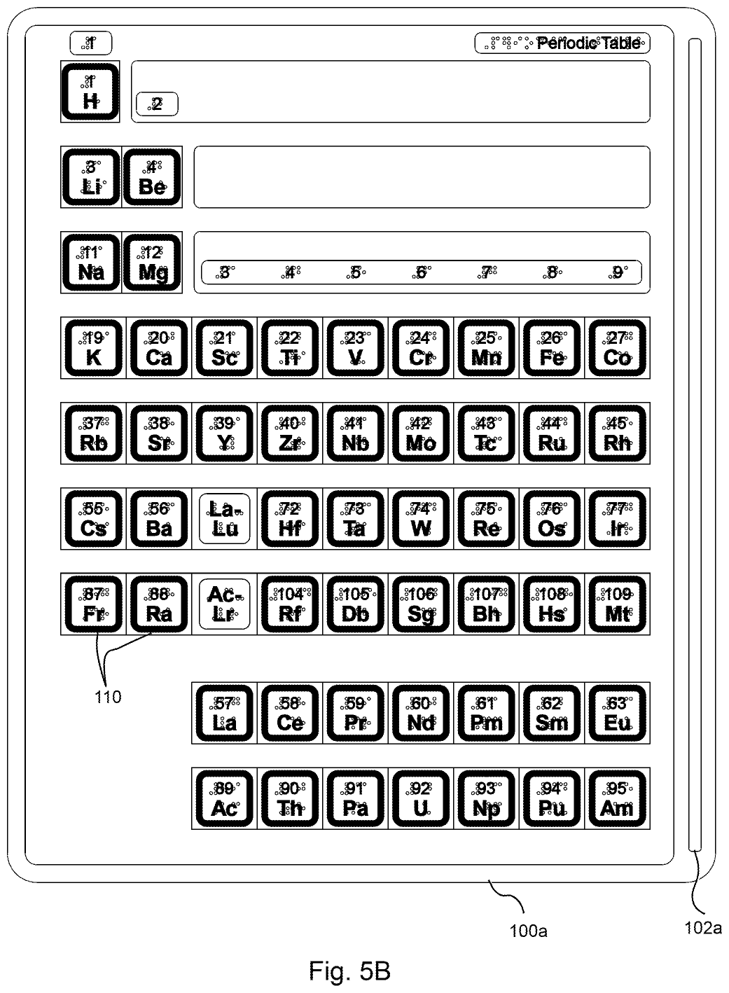

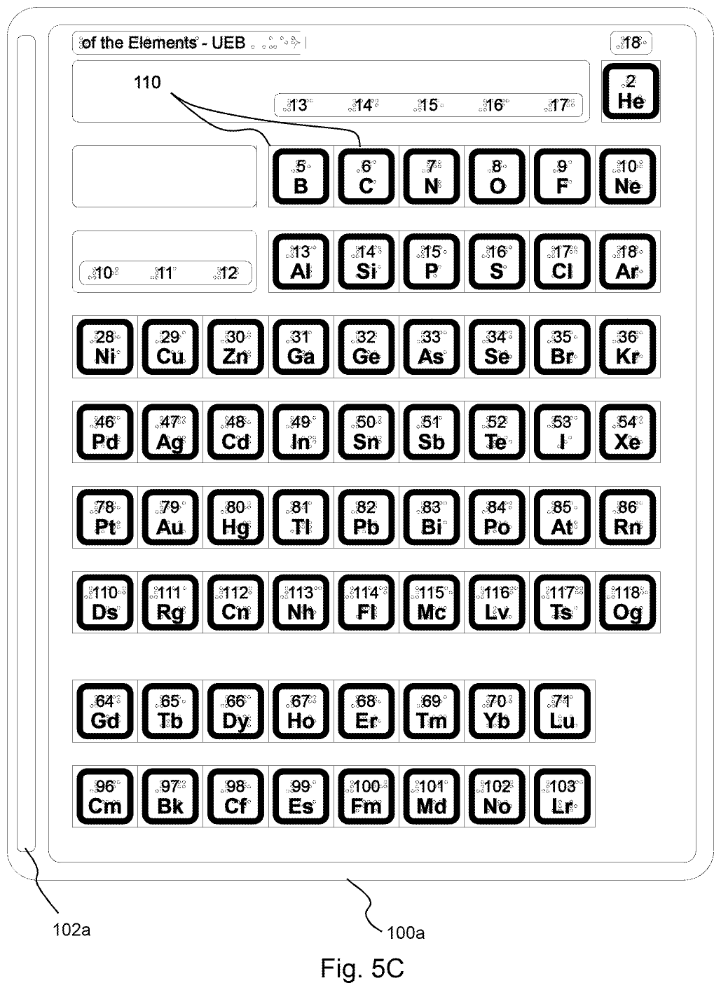

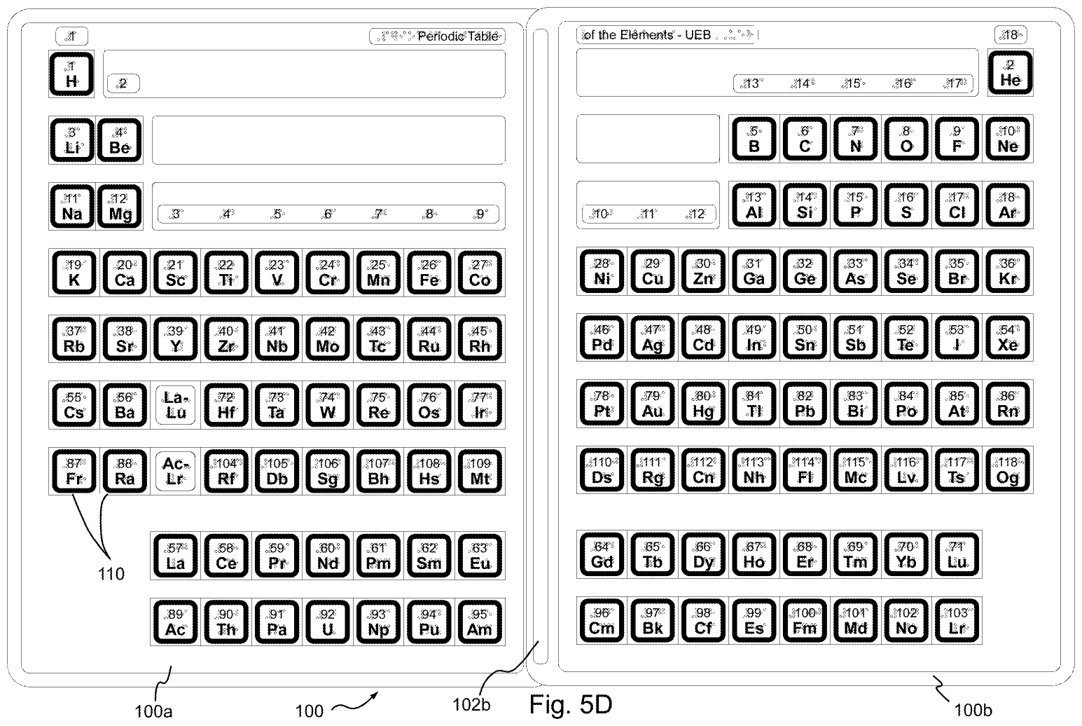

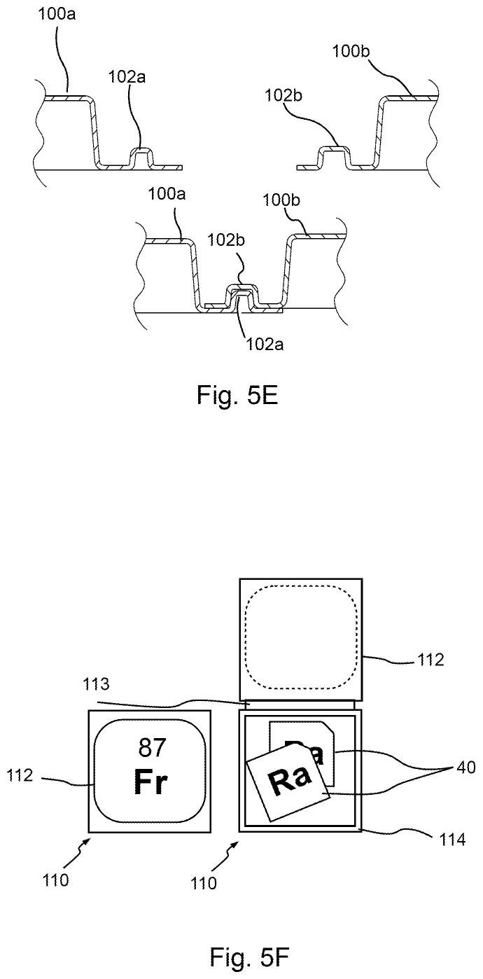

Multiple copies of each of movable tiles 40 and thus multiple copies of each of the corresponding symbols may be provided. Similarly, multiple copies of extending bond line components 50a-d, 50′ and support components 60 may be provided. Like tiles and/or components may, for example, be stored in groups at predetermined positions or student-chosen positions for easy retrieval. For example, groups of like tiles can be stored around the perimeter of board 30 as illustrated in FIG. 1A as well as in a storage device such as a multi-compartment storing device 100 for moveable tiles 40 as illustrated in FIGS. 5A through 5D. In a number of embodiments, storage device 100 is provided in the manner, form, or format of the periodic table of the elements. In that regard, the periodic table of elements (sometimes referred to simply as the periodic table) is a table that displays all elements currently known (that is, all 118 elements currently known). Briefly, the elements are arranged in periods (rows) and group (columns) according to the number of electron shells and their electronic configuration. In the periodic table of elements, the elements are arranged in the order of increasing atomic number across a period from left to right. Each element has one more proton in the nucleus thereof compared to the preceding element. Each group (column) of elements includes elements having similar physical or chemical characteristics associated with or predominantly determined by the number of electrons in the outermost or valence shell. There are 18 groups in the periodic table of element corresponding to the 18 columns thereof.

In a number of embodiments, board 30 has sufficient surface area to allow storage of movable tiles 40 around the perimeter of board 30 while providing sufficient room in the center of the board for the student to relatively quickly construct one or more chemistry representations. Positioning of movable tiles 40 around the perimeter of board 30 enables, for example, rapid construction of chemistry representations so that a visually impaired student can, for example, follow spoken instructions while in a classroom (which may be a standard classroom with other, sighted students) and replicate on board 30 chemical representations that may, for example, be drawn or otherwise displayed on a blackboard or other display by an instructor.

As set forth above, movable tiles 40 and/or other components, or a portion of the total number thereof, may be stored off of board 30. In a number of embodiments, the movable tiles are stored in a multicompartmental storage container 100. Each group of like moveable tiles 40 may, for example, be stored in an individual compartment of storage container 110 (separate from other groups of like movable tiles 40) to facilitate quick retrieval of a desired element/symbol. Storing the chemical element tiles in an organized fashion, while allowing easy access, may be accomplished using, for example, thermoformed tray sections with a plurality of relatively small compartments. In the embodiment illustrated in FIGS. 5A through 5F, device/system 10 includes two sections or two tray sections 100a and 100b containing numerous small compartments or boxes 110 arranged in the same manner or format as the chemical elements are arranged in the periodic table of the elements. Sections 100a and 100b may, for example, be attachable to form storage device 100 via cooperating connective elements, components or connectors such as snap-fitting or friction-fitting components. In the illustrated embodiment, such cooperating connectors include a raised, extending flange 102a and a raised extending seating 102b (see, for example, FIGS. 5A through 5E). By arraigning compartments 110 of tray storage device 100 into the form or format of a periodic table of the elements, a user/student may readily locate needed tiles and, at the same time, become more familiar with the structure of the periodic table. FIG. 5F illustrates an enlarged view of one of the many small compartments 110 of storage device 100 with a hinged lid 112 in an opened state to expose a box-like volume 114 for storage of movable elements 40 therein. In the embodiment of FIG. 5F lid 112 to connected to box-like volume 114 via a hinge 113 such as an integrally formed plastic hinge as known in the polymer arts. In a number of embodiments, the upper side or surface of lids 112 include visual as well as Braille indicia of the corresponding element and its atomic number.

Storage device 100 may, for example, be formed from one or more polymeric/plastic materials as known in the arts. Fabrications methods as described herein for formation of tiles 40 may also be used in connection with storage device 100.

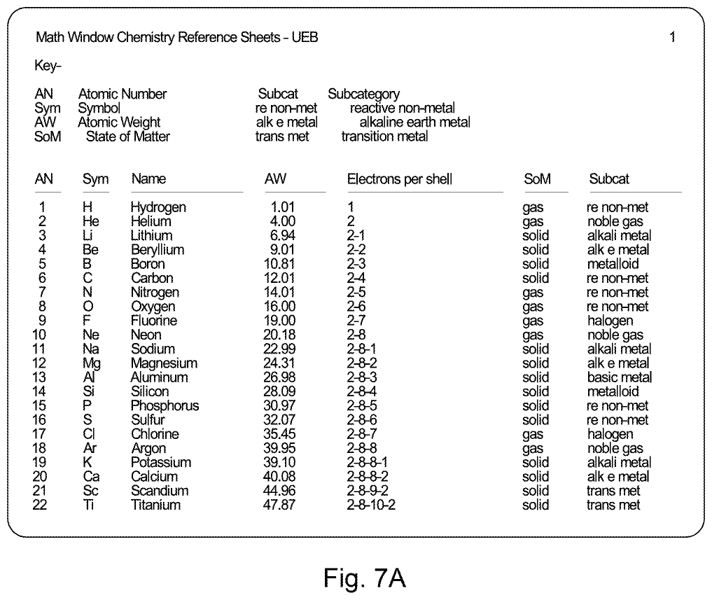

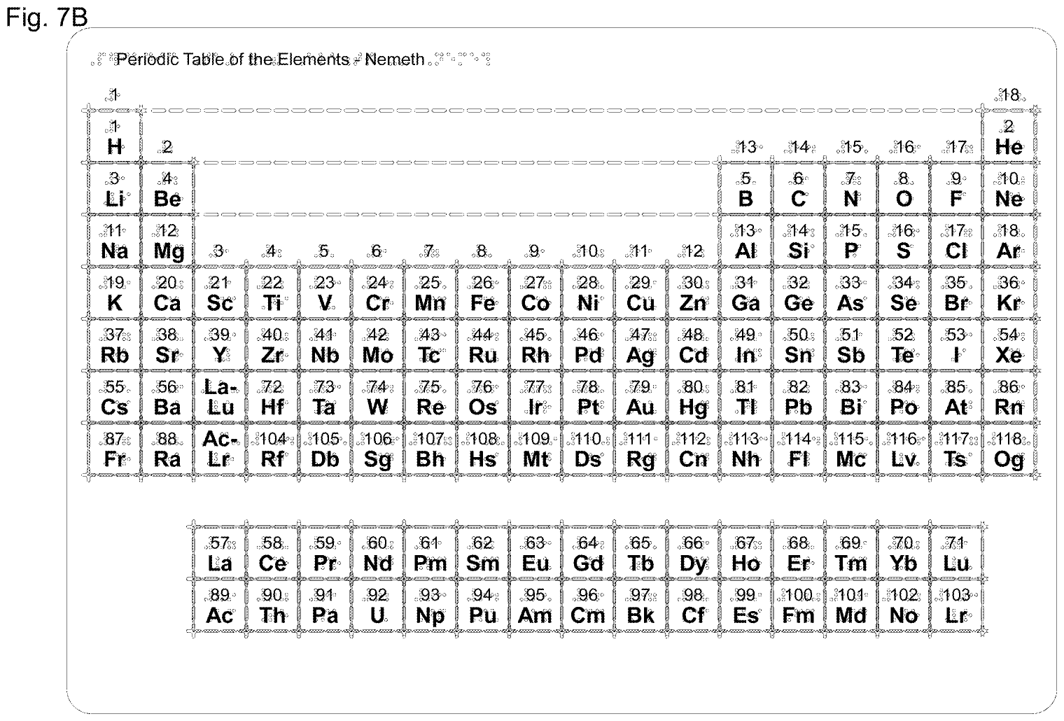

A periodic table of the elements used by sighted students typically has a significant amount of information about each element such as: element symbol, element name, atomic number, atomic weight, number of electrons per shell, state of matter, and element subcategory. Because of the size of Braille symbols, there may be sufficient space on periodic-table-formatted storage container 100 for only limited information (for example, the atomic number and symbol in the illustrated embodiment). In a number of embodiments, the systems and devices hereof may thus further include chemistry reference sheets as illustrated in FIGS. 7A (information on elements) and 7B (periodic table of elements). Such chemistry reference sheets may, for example, include additional information in both print and Braille, for both the visually impaired student and a sighted instructor. Such information may, for example, include atomic number, element symbol, element name, atomic weight, electron shells, state of matter, and/or element subcategory. Although references as sheets, the chemistry reference sheets are preferably formed from durable and relatively rigid materials such as polymeric/plastic materials. In a number of embodiments hereof, the reference sheets were formed from polymeric materials using methods the same as or similar to the methods for forming tiles 40 described herein.

The foregoing description and accompanying drawings set forth a number of representative embodiments at the present time. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

What is claimed is:

1. A system for instructing chemistry, comprising:
a device comprising a work surface;
a frame around the work surface, and
movable tiles, each of the movable tiles comprising, on a front surface thereof, at least a portion of a visible chemistry symbol thereon readable via eyesight, each of the movable tiles further comprising Braille indicia on the front surface thereof corresponding to the at least a portion of the visible chemistry symbol, each of the movable tiles further comprising an attachment member on a rearward surface to attach the moveable tile to the work surface, the attachment member being adapted to allow the moveable tile to be removed from the work surface and to be slidably positionable to generally any position on the work surface once attached thereto, the frame defining an abutment boundary for positioning of the movable tiles, and
a storage device for at least a portion of the movable tiles which comprise a symbol of one of a plurality of chemical elements thereof, the storage device comprising a plurality of separate compartments for the at least a portion of the moveable tiles, each of the plurality of separate compartments comprising a visible chemistry symbol of one of the plurality of chemical elements thereon readable via eyesight and a Braille indicia of the one of the plurality of chemical elements thereon, the plurality of separate compartments being arranged in space in the format of a periodic table of elements.

2. The system of claim 1 wherein the work surface has sufficient surface area to provide for positioning a plurality of the moveable tiles around at least a portion of a perimeter of the work surface bounded by the frame from which the moveable tile can be slid to form a standard chemistry expression.

3. The system of claim 1 wherein magnetic attraction is used to maintain the attachment member in movable connection with the work surface.

4. The system of claim 1 further comprising one or more reference documents comprising information in the form of Braille indicia.

5. The system of claim 4 wherein the one or more reference documents provides information in the form of Braille indicia on the plurality of chemical elements to supplement information provided on each of the plurality of separate compartments.

6. The system of claim 1 wherein each of the plurality of separate compartments independently comprises a movable cover comprising the visible chemistry symbol of one of the plurality of chemical elements and the Braille indicia of the one of the plurality of chemical elements on an upper surface thereof.

7. The system of claim 6 wherein the movable cover of each of the plurality of separate compartments is connected to a body of each of the plurality of separate compartments via a hinge mechanism.

8. The system of claim 6 wherein the upper surface of the movable cover of each of the plurality of separate compartments further comprises a visible indicia of an atomic number of the one of the plurality of chemical elements and the Braille indicia of the atomic number of the one of the plurality of chemical elements.

9. The system of claim 1 further comprising a plurality of support components, each of the plurality of support components comprising a first seating via which one of the moveable tiles is positionable to be in operative connection with the support component, each of plurality of support components further comprising an attachment member on a rearward surface to attach the support component to the work surface, the attachment member being adapted to allow the support component to be removed from the work surface and to be slidably positionable to generally any position on the work surface once attached thereto, and a plurality of extending bond line components, wherein a user can form a structure on the work surface representing a molecule by arranging two or more of the plurality of support components in spaced relation with one or more of the plurality of extending bond line components extending between the two or more of the plurality of support components.

10. The system of claim 9 wherein magnetic attraction is used to maintain the attachment member of each of the plurality of support components in movable connection with the work surface.

11. The system of claim 9 wherein each of the plurality of support components further comprises a second seating via which one of the moveable tiles is positionable to be in operative connection with the support component, the first seating being dimensioned to seat one of the plurality of movable tiles having a first size, the second seating being dimensioned to seat one of the plurality of movable tiles having a second size, different from the first size.

12. The system of claim 9 wherein one or more of the plurality of extending bond line components comprises an attachment member on a rearward surface to attach the extending bond line component to the work surface, the attachment member being adapted to allow the extending bond line component to be removed from the work surface and to be slidably positionable to generally any position on the work surface once attached thereto.

13. The system of claim 12 wherein each of the one or more of the plurality of extending bond line components comprises, on a front surface thereof, a visible representation thereon readable via eyesight of one of a single bond, a double bond, a triple bond or a quadruple bond, each of the extending bond line components further comprising Braille indicia or other tactile indicia on the front surface thereof corresponding to the one of the single bond, the double bond, the triple bond or the quadruple bond.

14. The system of claim 9 wherein one or more of the of the plurality of extending bond line components comprises an adhesive surface to removably attach the extending bond line component to the work surface, wherein a single bond line is represented by one of one or more extending bond line components, a double bond line is represented by two of one or more extending bond line components, a triple bond line is represented by three of one or more extending bond line components, and a quadruple bond line is represented by four of one or more extending bond line components

15. A device for instructing chemistry, comprising:
a work surface;
a frame around the work surface,
movable tiles, each of the movable tiles comprising, on a front surface thereof, at least a portion of a visible chemistry symbol thereon readable via eyesight, each of the movable tiles further comprising Braille indicia on the front surface thereof corresponding to the at least a portion of the visible chemistry symbol, each of the movable tiles further comprising an attachment member on a rearward surface to attach the moveable tile to the work surface, the attachment member being adapted to allow the moveable tile to be removed from the work surface and to be slidably positionable to generally any position on the work surface once attached thereto, the frame defining an abutment boundary for positioning of the movable tiles, the movable tiles comprising a plurality of chemical element tiles and a plurality of moveable tiles comprising a visible chemistry symbol of one of the plurality of chemical elements thereon readable via eyesight and a Braille indicia of the one of the plurality of chemical elements thereon, a plurality of support components, each of the plurality of support components comprising a first seating via which one of the moveable tiles is positionable to be in operative connection with the support component, each of plurality of support components further comprising an attachment member on a rearward surface to attach the support component to the work surface, the attachment member being adapted to allow the support component to be removed from the work surface and to be slidably positionable to generally any position on the work surface once attached thereto; and
a plurality of extending bond line components;
wherein a user can form a structure on the work surface representing a molecule by arranging two or more of the plurality of support components in spaced relation with one or more of the plurality of extending bond line components extending between the two or more of the plurality of support components.

16. The device of claim 15 wherein the work surface has sufficient surface area to provide for positioning a plurality of the moveable tiles around at least a portion of a perimeter of the work surface bounded by the frame from which the moveable tile can be slid to form a standard chemistry expression.

17. The device of claim 15 wherein magnetic attraction is used to maintain the attachment member in movable connection with the work surface.

18. The device of claim 15 wherein magnetic attraction is used to maintain the attachment member of each of the plurality of support components in movable connection with the work surface.

19. The device of claim 15 wherein each of the plurality of support components further comprises a second seating via which one of the moveable tiles is positionable to be in operative connection with the support component, the first seating being dimensioned to seat one of the plurality of movable tiles having a first size, the second seating being dimensioned to seat one of the plurality of movable tiles having a second size, different from the first size.

20. The device of claim 15 wherein one or more of the plurality of extending bond line components comprises an attachment member on a rearward surface to attach the support component to the work surface, the attachment member being adapted to allow the support component to be removed from the work surface and to be slidably positionable to generally any position on the work surface once attached thereto.

21. The device of claim 20 wherein each of the one or more of the plurality of extending bond line components comprises, on a front surface thereof, a visible representation thereon readable via eyesight of one of a single bond, a double bond, a triple bond or a quadruple bond, each of the movable tiles further comprising Braille indicia on the front surface thereof corresponding to the one of the single bond, the double bond, the triple bond or the quadruple bond.

22. The device of claim 15 wherein one or more of the of the plurality of extending bond line components comprises an adhesive surface to removably attach the extending bond line component to the work surface, wherein a single bond line is represented by one of one or more extending bond line components, a double bond line is represented by two of one or more extending bond line components, a triple bond line is represented by three of one or more extending bond line components, and a quadruple bond line is represented by four of one or more extending bond line components.
